(19) United States
(12) Patent Application Publication
(10) Pub. No.: US 2003/0022004 A1
(43) Pub. Date: Jan. 30, 2003

(54) Dummy plate for offset printing

(76) Inventors: Michael Dorr, Mainz (DE); Andreas Elsasser, Idstein (DE); Wolfgang Ranecky, Dreieich (DE); Engelbert Pliefke, Wiesbaden (DE)

Correspondence Address: Connolly Bove Lodge & Hutz LLP, P.O. Box 2207, Wilmington, DE, 19899-2207, US

(21) Appl. No.: 10/178,521

(22) Filed: Jun. 24, 2002

(30) Foreign Application Priority Data
Jun. 29, 2001 (DE) 101 31 025.0

(51) Int. Cl. B32B 15/08

(52) U.S. Cl. 428/458; 428/472.2

(57) ABSTRACT

The invention relates to a dummy plate for offset printing which essentially consists of a plate, foil or band-shaped, mechanically cally and/or electrochemically roughened, anodically oxidized and hydrophilized aluminium support and a non-light-sensitive, water-soluble layer applied thereto, where the layer comprises at least one copolymer which has monomer units having pendant groups of the formulae —CO—NH— and/or —CO—N< and whose solubility in water at a temperature of 25° C. is at least 50 g/l, and at least one acidic compound and/or a salt thereof. Due to the coating, the surface remains permanently hydrophilic. The dummy plate can be used in the printing machine without pretreatment. During printing, the layer is completely removed by the fountain solution after a short time without the paper web and the rubber blanket cylinder sticking to one another during proof printing.

### FIELD OF THE INVENTION

The present invention relates to a dummy plate for offset printing which essentially consists of a mechanically and/or electrochemically roughened, anodically oxidized, hydrophilized aluminium support and a non-light-sensitive, water-soluble layer applied thereto. In addition, it relates to a process for the production of the dummy plate.

### BACKGROUND OF THE INVENTION

In a printing machine, a plurality of plates are generally clamped onto the printing cylinder alongside one another and one after the other. Dummy plates are planographic printing plates without ink-carrying areas. They are employed where the paper web is not to be printed. A dummy plate has the job of taking up the fountain solution applied over the entire cylinder width and transferring it to the paper web. At the same time, the dummy plate must not take up the printing ink in order to avoid transferring the latter to the paper, i.e. the plate must not “tone”. A particularly large number of dummy plates are necessary if individual colours are not required on all pages in multicolour offset printing and the respective inking units are then not to transfer any ink.

Dummy plates are usually roughened and anodically oxidized aluminium plates. If desired, they may additionally have been subjected to hydrophilizing treatment, for example with phosphorus-containing compounds, as described in DE-A 44 23 410. The disadvantage of these dummy plates consists in that they react very sensitively to finger-prints and other external influences. Fingerprints, for example, result in ink take-up and thus in toning in the printing machine. In addition, the hydrophilicity of dummy plates of this type is impaired over time, meaning that they take up ink and tone in the printing machine for this reason. This effect is particularly evident If the dummy plates have been exposed to ambient air for an extended period without protection and have, for example, taken up moisture, dust or traces of oil. In order to eliminate the consequences of fingerprints and to raise the hydrophilicity of the aluminium surface back to the original value, dummy plates are subjected to the normal development process with subsequent gumming. This cleans and hydrophilizes the surface of the printing plate. Subsequent gumming preserves the surface. The dummy plates treated in this way have a significantly lower tendency towards toning in the printing machine.

EP-A 790 530 discloses a dummy plate whose surface exhibits virtually no increase in hydrophilicity, even after extended storage, and is less sensitive to fingerprints. This dummy plate essentially consists of a mechanically and/or electrochemically roughened, anodically oxidized and hydrophilized aluminium plate which has been coated with a mixture of an organic polymer, preferably polyvinyl alcohol, and an inorganic compound which is acidic in water, preferably an inorganic phosphate or sulphate. The organic polymer has a solubility in water of at least 2 g/l at room temperature. The coating may also comprise dyes, surfactants or other additives.

The dummy plate for offset printing disclosed in EP-A 894 642 consists of a roughened, anodically oxidized and optionally hydrophilized aluminium support and a coating which comprises a water-soluble, organic compound having at least one OH- or NH-acidic group having a pKa value of ≦8 or a salt of this compound, preferably also a water-soluble polymeric film former. The organic compound preferably contains at least 3 acid groups, which are preferably phosphonic acid or sulphonic acid groups. The water-soluble polymeric film former is preferably a polyvinyl alcohol, polyvinyl-pyrrolidone, a starch derivative or gum arabic. The coating is thinner than the average surface roughness of the support.

However, dummy plates whose coating comprises polyvinyl alcohol as an essential constituent are problematic in one respect: at the beginning of printing, i.e. during so-called “free running” of the plates, the constituents of the coating partially dissolved by the fountain solution are transferred to the rubber blanket cylinder, where they frequently remain adhering and are not or not completely transferred to the paper web. It has been found that the composition of the fountain solution and even that of the rubber blanket cleaning agent used beforehand play a role here. The coating constituents remaining on the rubber blanket cylinder cause a stronger interaction with the paper web than normal. In roll offset printing machines, this can extend so far that the paper web tears and the printing process has to be interrupted. In addition, coatings comprising polyvinylpyrrolidone are hygroscopic, and the coating consequently easily sticks to the interleaving paper if the plates are not stored under extremely dry conditions.

### OBJECTS OF THE INVENTION

The object of the invention was to develop a dummy plate which can be stored for the longest possible time without its surface becoming less hydrophilic. In addition, the polymeric film formers should not adhere or even stick to the rubber blanket of the offset printing machine during free-running of the plate—irrespective of the choice of fountain solution—so that the paper web no longer tears.

It has now been found that the object can be achieved by means of water-soluble copolymers which contain monomer units having pendant groups of the formulae —CO—NH— or —CO—N<.

### SUMMARY OF THE INVENTION

The present application accordingly relates to a dummy plate for offset printing which essentially consists of a plate-, foil- or band-shaped, mechanically and/or electrochemically roughened, anodically oxidized and hydrophilized aluminium support and a non-light-sensitive, water-soluble layer applied thereto, which is characterized in that the layer comprises at least one copolymer which contains monomer units having pendant groups of the formulae —CO—NH— and/or —CO—N< and whose solubility in water at a temperature of 25° C. is at least 50 g/l, and at least one acidic compound and/or a salt thereof. The solubility of the water-soluble copolymer in water at a temperature of 25° C. is preferably greater than 100 g/l, particularly preferably even greater than 200 g/l.

The pendant groups of the formulae —CO—NH— or —CO—N< are preferably a constituent of a ring structure, in particular of a 5- to 7-membered ring. Groups of this type are found, in particular, in vinylpyrrolidone or vinylcaprolactam units. However, they may also be a constituent of an acyclic side chain. Examples thereof are N-alkyl(meth)acrylamide, N,N-dialkyl(meth)acrylamide, (3acryloyl-aminopropyl)trimethylammonium chloride and (3-methacryloylamino-propyl)trimethylammonium chloride units. The term “-(meth)acryl-amide” here denotes -acrylamide or -methacrylamide. In connection with the present invention, “copolymer” denotes a polymer having 2 or more different monomer units, also including polymers which consist of two or more different monomer units having pendant amide groups of the said formulae. The water-soluble layer may also comprise further constituents, in particular sequestering agents, biocidally active agents and/or dyes.

The copolymer generally has a molecular weight Mₙ of from about 3000 to 1,000,000, preferably from 10,000 to 200,000. If the copolymer contains polyvinylpyrrolidone units, their proportion should then generally not be greater than 70 mol % in order that the layer does not become hygroscopic. The various monomer units in the copolymers generally have a random distribution; however, they may also be block copolymers. The further monomer units are preferably vinyl ester, acrylate or methacrylate units, such as vinyl acetate, acrylic acid or methacrylic acid units.

The proportion of the water-soluble copolymer is generally from 20 to 95% by weight, preferably from 25 to 75% by weight, in each case based on the total weight of the layer.

In addition to at least one copolymer of the said type, the water-soluble layer also comprises at least one acidic compound or a salt thereof. The compound may be inorganic or organic, but is preferably organic. Together with the water-soluble copolymer, it keeps the support hydrophilic over a long period. Suitable compounds are described in DE-A 39 03 001 and 40 30 056. The inorganic compounds include, in particular, mineral acids, for example phosphoric and sulphuric acid, and water-soluble acidic salts thereof, for example phosphates. Preferred salts are ammonium, alkali metal or alkaline-earth metal phosphates. Particular preference is given to phosphoric acid, alkali metal and ammonium dihydrogenphosphate. Suitable organic, acidic compounds are those which contain carboxyl, sulpho and/or phosphono groups. They are generally of low molecular weight. Examples are benzenephosphonic acid, benzenesulphonic and benzene-disulphonic acid and alkali metal salts thereof (in particular the sodium and potassium salts). The proportion of the acidic compound(s) and/or salts thereof is generally from 3 to 40% by weight, preferably from 5 to 25% by weight, in each case based on the total weight of the layer.

An optionally present surfactant serves to reduce the surface tension of the coating solution and thus to improve the wettability of the support. The surfactants may be anionic surfactants, such as sodium dodecylsulphate, sodium dodecylsulphonate, alkylamino-carboxylates and -dicarboxylates, cationic surfactants, such as tetraalkylammonium salts, or nonionic surfactants, such as poly-ethylene glycol monoalkyl ethers. The proportion of surfactant(s) is generally up to 10% by weight, preferably from 2 to 7% by weight, in each case based on the total weight of the layer.

It has furthermore proven favourable to add a complexing agent (=sequestering agent). These are, for example, aminocarboxylic acids, aminophosphonic acids or polybasic carboxylic acids, such as citric acid, and salts thereof, in particular the alkali metal salts. The proportion of complexing agent(s) is generally up to 20% by weight, preferably from 5 to 15% by weight, in each case based on the total weight of the layer.

The layer may furthermore comprise a biocide as preservative. Examples thereof are isothiazolin-3-one derivatives, 2-bromo-2-nitropropane-1,3-diol or chloroacetamide. The proportion of biocide(s) is generally up to 2% by weight, preferably from 0.01 to 1.0% by weight, in each case based on the weight of the layer.

The layer may also comprise further film-forming polymers, such as dextrin, or gum arabic. The proportion thereof is up to 50% by weight, preferably from 10 to 40% by weight, in each case based on the weight of the layer.

Finally, for visual monitoring of homogeneity, the layer may also comprise a dye.

In the production of the dummy plates according to the invention, a dilute aqueous solution comprising the said constituents is generally applied to the roughened and hydrophilized aluminium support. The proportion of non-volatile constituents in this solution depends on the coating method. If the coating is applied with the aid of so-called flow coaters, the proportion of non-volatile constituents is advantageously from about 0.5 to 5.0% by weight, based on the total weight of the solution.

After drying, the water-soluble layer generally has a weight of from 0.1 to 2.5 g/m², preferably from 0.15 to 0.5 g/m². In addition, a lower layer weight minimizes the risk of the plates adhering to one another or to the interleaving paper. The thickness of the water-soluble layer is thus generally less than the average roughness Ra of the aluminium support material (where the roughness is determined optically).

The support plates, foils or bands from which the dummy plates according to the invention are produced consist of aluminium or alloys thereof. They are mechanically and/or electrochemically roughened. The roughening is preferably carried out electrochemically in dilute hydrochloric acid. During subsequent anodic oxidation, preferably in dilute hydrochloric or nitric acid, an oxide layer forms on the aluminium. The oxidation is preferably controlled in such a way that the oxide layer has a weight of from 1 to 5 g/m².

The aluminium material prepared in this way is then hydrophilized. The hydrophilization is preferably carried out using phosphorus-containing compounds. Particular preference is given here to organic polymers having phosphorus-containing groups, in particular phosphinic acid or phosphonic acid groups. Polymers of this type are described, for example, in EP-A 069 320 and EP-A 069 318. Particular preference is given to polyvinylphosphonic acid. The hydrophilizing agent is generally applied in the form of an aqueous solution, which is then dried.

During application of the hydrophilic protective layer, coating flaws may form, causing undesired toning during printing. Such flaws can be avoided if the aqueous coating solution is applied a number of times to the roughened and hydrophilized aluminium support and dried in each case, so that the coating flaws which occurred in the previous application are compensated for. The aqueous coating solution is preferably applied twice and dried in each case. In this way, flaws which have occurred in the preceding coating are compensated for. Uncoated areas which later result in toning are reliably avoided in this way.

The dummy plate according to the invention does not need to be subjected to the development process, even after an extended storage time, but instead can be clamped directly onto the printing cylinder of the printing machine after bevelling. The water-soluble layer is dissolved off by the fountain solution (“wiping water”), uncovering the hydrophilic support surface.

### EXAMPLES

In the examples, pbw stands for part(s) by weight. Percentages are per cent by weight, unless stated otherwise.

The following aluminium supports were used for the production of the dummy plates:

S1: An aluminium band which has been electrochemically roughened in hydrochloric acid (Ra value 1.25 μm, determined using an optical microprobe having a measurement spot radius of 1 μm) was anodized in sulphuric acid. The weight of the oxide layer was 3 g/m². The band was subsequently hydrophilized using a 0.2% strength aqueous polyvinylphosphonic acid solution at 60° C. for 10 seconds.

S2: An aluminium band which has been electrochemically roughened in hydrochloric acid (Ra value 0.95 μm, determined using an optical microprobe having a measurement spot radius of 1 μm) was anodized in sulphuric acid. The weight of the oxide layer was 2 g/m². The band was subsequently hydrophilized using a 0.1% strength aqueous solution of phosphonomethylated polyethyleneimine and then using a 0.2% strength aqueous polyvinylphosphonic acid solution at 60° C. for 10 seconds in each case.

S3: An aluminium band was roughened using a 40% strength aqueous slurry of aluminosilicates having a mean particle size of 40 μm (Ra value 0.8 μm) and anodized in sulphuric acid. The weight of the resultant oxide layer was 1.8 g/m². The band was then hydrophilized using a 0.2% strength aqueous polyvinylphosphonic acid solution at 60° C. for 10 seconds.

The coating of supports S1 to S3 was in each case carried out using a 1% strength aqueous solution. After drying, the layer weight was in each case 0.25 g/m². The aqueous coating solutions comprised the following non-volatile constituents:

### Example 1

50 pbw of vinylpyrrolidone-vinyl acetate copolymer, monomer ratio 60:40 (®Luviskol VA64 from BASF AG),

20 pbw of benzene-1,3-disulphonic acid Na salt,

20 pbw of dextrin,

9.8 pbw of citric acid monohydrate (sequestering agent) and

0.2 pbw of chloroacetamide (biocide).

The pH was set to 6 using NaOH.

### Example 2

60 pbw of vinylpyrrolidone-vinyl acetate copolymer, monomer ratio 60:40 (®Luviskol VA64 from BASF AG),

10 pbw benzenephosphonic acid Na salt,

25 pbw of dextrin,

4.8 pbw of the trisodium salt of N,N-biscarboxymethyl-β-alanine (sequestering agent) and

0.2 pbw of 2-methyl-5,6-dihydro-2H,4H-cyclopenta[d]isothiazol-3-one (®Promexal X50, described by the manufacturer Reneca as 2-methyl-4,5-trimethylene-4-isothiazolin-3-one) (biocide).

The pH was set to 7 using NaOH.

### Example 3

50 pbw of vinylpyrrolidone-(3-methacryloylaminopropyl)tri-methylammonium chloride copolymer(®Gafquat HS-100 ISP),

20 pbw of benzene-1,3-disulphonic acid Na salt,

20 pbw of dextrin,

9.8 pbw of citric acid monohydrate (sequestering agent) and

0.2 pbw of chloroacetamide (biocide).

The pH was set to 5 using NaOH.

### Example 4

60 pbw of vinylpyrrolidone-vinylcaprolactam copolymer, monomer ratio 1:1 (®Luvitec VPC 55 K65W from BASF)

10 pbw of benzene-1,3-disulphonic acid Na salt,

25 pbw of dextrin,

4.8 pbw of the trisodium salt of N,N-biscarboxymethyl-β-alanine (sequestering agent) and

0.2 pbw of chloroacetamide (biocide).

The pH was set to 6 using NaOH.

### Comparative Example C1

50 pbw of polyvinyl alcohol having a degree of hydrolysis of 75-79 mol % and a degree of polymerization Pₙ=300,

20 pbw of benzene-1,3-disulphonic acid Na salt,

20 pbw of dextrin,

9.8 pbw of citric acid monohydrate (sequestering agent) and

0.2 pbw of chloroacetamide (biocide).

The pH was set to 6 using NaOH.

### Comparative Example C2

60 pbw of polyvinyl alcohol having a degree of hydrolysis of 75-79 mol % and a degree of polymerization Pₙ=300,

10 pbw of benzenephosphonic acid Na salt,

25 pbw of dextrin,

4.8 pbw of the trisodium salt of N,N-biscarboxymethyl-β-alanine (sequestering agent) and

0.2 pbw of 2-methyl-5,6-dihydro-2H,4H-cyclopenta[d]isothiazol-3-one (biocide).

The pH was set to 6 using NaOH.

### Comparative Example C3

For comparison, supports S1 to S3 remained uncoated.

The plates, without further pretreatment, were subsequently for printing in a roll offset printing machine, model KBA-Express from König & Bauer AG. The fountain solution additive used was ®Acedin Web 1520 from DS Druckereiservice GmbH.

The following table shows the results of the printing test for free-running behaviour at the experimental settings and the tendencies towards sticking and paper web tears resulting therefrom.

| | Support | | | | | | | | |
|---|---|---|---|---|---|---|---|---|---|
| Examples | S1 | | | S2 | | | S3 | | |
| No. | a | b | c | a | b | c | a | b | c |
| 1 | + | + | + | + | + | + | + | + | + |
| 2 | + | + | + | + | + | + | + | + | + |
| 3 | + | + | + | + | + | + | + | + | + |
| 4 | + | + | + | + | + | + | + | + | + |
| C1 | 0 | + | + | − | + | + | − | + | + |
| C2 | − | + | + | − | + | + | − | + | + |
| C3 | + | | − | + | | − | + | | − |

a) Tendency to stick in the “free-running behaviour on the roll offset machine” test
− paper web tears
0 paper residues from the surface stick to the rubber blanket (critical area)
+ no problems
b) Proof printing after storage for 20 hours, 100° C./<20% rel. humidity
− tone-free proof printing afrer 30 sheets not guaranteed
+ problem-free proof printing (free running after fewer than 30 sheets guaranteed)
c) Proof printing after storage for 20 hours, 40° C./80% rel. humidity
− tone-free proof printing after 30 sheets not guaranteed
+ problem-free proof printing (free running after fewer than 30 sheets guaranteed)

1. Dummy plate for offset printing which essentially consists of a plate-, foil- or band-shaped, mechanically and/or electro-chemically roughened, anodically oxidized and hydrophilized aluminium support and a non-light-sensitive, water-soluble layer applied thereto, characterized in that the layer comprises at least one copolymer which has monomer units having pendant groups of the formulae —CO—NH— and/or —CO—N< and whose solubility in water at a temperature of 25° C. is at least 50 g/l, and at least one acidic compound and/or a salt thereof.

2. Dummy plate according to claim 1, characterized in that the solubility of the water-soluble copolymer in water at a temperature of 25° C. is greater than 100 g/l, preferably greater than 200 g/l.

3. Dummy plate according to claim 1, characterized in that the pendant groups of the formulae —CO—NH— or —CO—N< are a constituent of a ring structure, in particular of a 5- to 7-membered ring.

4. Dummy plate according to claim 1, characterized in that the proportion of the water-soluble copolymer is from 20 to 95% by weight, preferably from 25 to 75% by weight, in each case based on the total weight of the layer.

5. Dummy plate according to claim 1, characterized in that the proportion of the acidic compound(s) and/or the salt(s) thereof is from 3 to 40% by weight, preferably from 5 to 25% by weight, in each case based on the total weight of the layer.

6. Dummy plate according to claim 1, characterized in that the water-soluble layer comprises sequestering agents, biocidally active agents, film-forming polymers, dyes and/or surfactants.

7. Dummy plate according to claim 6, characterized in that the proportion of sequestering agent(s) is up to 20% by weight, preferably from 5 to 15% by weight, in each case based on the total weight of the layer.

8. Dummy plate according to claim 6, characterized in that the proportion of biocidally active agents is up to 2% by weight, preferably from 0.01 to 1.0% by weight, in each case based on the weight of the layer.

9. Dummy plate according to claim 6, characterized in that the proportion of film-forming polymers is up to 50% by weight, preferably from 10 to 40% by weight, in each case based on the weight of the layer.

10. Dummy plate according to claim 6, characterized in that the proportion of surfactants is up to 10% by weight, preferably from 2 to 7% by weight, in each case based on the total weight of the layer.

11. Process for the production of the dummy plate according to one or more of claims 1 to 10, characterized in that an aqueous solution comprising at least one copolymer which has monomer units having pendant groups of the formulae —CO—NH— and/or —CO—N< and whose solubility in water at a temperature of 25° C. is at least 50 g/l, and at least one acidic compound and/or a salt thereof are applied to an aluminium support, and the resultant layer is subsequently dried.
